(19) United States
(12) Patent Application Publication
(10) Pub. No.: US 2025/0023190 A1
(43) Pub. Date: Jan. 16, 2025

(54) SOFT PACK BATTERY

(71) Applicant: Microvast, Inc., Stafford, TX (US)

(72) Inventors: Jiangping YI, Huzhou (CN); Ting GUO, Huzhou (CN); Xiaolong ZHOU, Huzhou (CN); Jiafeng MENG, Huzhou (CN); Sihao LI, Huzhou (CN)

(73) Assignee: Microvast, Inc., Stafford, TX (US)

(21) Appl. No.: 18/705,997

(22) PCT Filed: Nov. 4, 2021
(86) PCT No.: PCT/CN2021/128676

§ 371 Date: Apr. 30, 2024

(51) Int. Cl. H01M 50/392; H01M 50/131; H01M 50/342

(52) U.S. Cl. CPC H01M 50/392; H01M 50/131; H01M 50/342

(57) ABSTRACT

The present application provides a soft pack battery, which comprises a packaging film provided with at least one breathable hole. The soft pack battery further comprises a breathable membrane. The breathable membrane seals the breathable hole, and the breathable membrane can block liquid while allowing gas to pass through. The gas in the soft pack battery can be discharged through the breathable membrane, thereby improving the safety performance and the service life of the battery.

### TECHNICAL FIELD

This application relates to the technical field of batteries, and in particular, to a soft pack battery.

### DESCRIPTION OF RELATED ART

In recent decades, the technology of lithium-ion batteries has developed rapidly and has become increasingly widespread in digital products, electric tools, and electric vehicles. As the energy density of the lithium-ion batteries improves continuously, people are concerned about battery safety performance. Lithium-ion batteries are divided into prismatic lithium batteries, cylindrical lithium batteries, and coin type lithium batteries according to their appearance, and are divided into aluminum shell lithium batteries, steel shell lithium batteries, and soft pack batteries according to their packaging materials. Among them, soft pack batteries have higher individual energy density and better safety performance, and soft pack batteries are generally packaged with aluminum-plastic film.

High nickel ternary materials, high voltage ternary materials, natural graphite, silicon-based negative electrodes and other materials in lithium-ion batteries are prone to oxidation or reduction of the electrolyte during the cycling process, thus leading to gas production in the battery cells. When the gas production is severe, it can cause deformation of the battery cells, affect performance, and even rupture the aluminum-plastic film, causing electrolyte leakage and posing safety hazards.

### BRIEF SUMMARY OF THE APPLICATION

### Technical Problem

The existing technology generally uses devices such as conduits and exhaust pipes to exhaust the gas produced in the battery, in order to improve the safety performance of the battery cell. However, this type of exhaust device has the following problems in use: 1. Due to the difficulty of close contact between this type of exhaust device and aluminum-plastic film, it is easy to cause packaging problems (i.e., unable to fully seal); 2. The rubber plugs used in conduits and exhaust pipes are prone to aging and have limited service life, which may not be effective after long-term use; 3. This type of exhaust device has a certain weight, and installing it on the battery will cause a significant decrease in the energy density of the battery cell.

### Technical Solution

The object of the present application is to provide a soft pack battery, aiming to solve the shortcomings of the background technology mentioned above. The gas inside the soft pack battery can be discharged through a breathable membrane, thereby improving the safety performance and service life of the battery.

An embodiment of the present application provides a soft pack battery, comprising a packaging film. At least one breathable hole is provided on the packaging film. The soft pack battery further comprises a breathable membrane, the breathable membrane is attached and connected to the packaging film at the position of the breathable hole. The breathable membrane seals the breathable hole, and the breathable membrane is capable of blocking liquid while allowing gas to pass therethrough.

In this way, the breathable membrane can block liquid while allowing gas to pass therethrough, so the electrolyte inside the packaging film cannot leak from the breathable membrane. Meanwhile, due to the continuous generation of gas inside the soft pack battery, the gas pressure inside the soft pack battery is generally higher than the external pressure. Under the pressure difference between the inside and outside of the soft pack battery, the gas inside the soft pack battery can be discharged through the breathable membrane, and the external gas cannot enter the soft pack battery through the breathable membrane.

In an achievable manner, at least one side of the soft pack battery is provided with one or more tabs, the packaging film is provided with a top sealing area at the position corresponding to the tabs, and the breathable hole is provided within the top sealing area.

In this way, when gas is generated inside the soft pack battery, the gas pressure is higher than the external pressure, and the soft pack battery is relatively weak at the tabs, so the gas is easy to rush out from the tabs. Therefore, setting the breathable hole at the position of the tabs in the top sealing area can better achieve the gas exhaust and safety improvement of the battery.

In an achievable manner, the tabs are provided on one side of the soft pack battery.

In an achievable manner, the tabs are provided on one side of the soft pack battery in a width direction of the soft pack battery, the top sealing area is provided on the side of the packaging film near the tabs, the top sealing area extends along a length direction of the soft pack battery, and the number of the breathable hole is one or more. When the number of the breathable hole is multiple, the multiple breathable holes can be arranged along the length direction of the soft pack battery.

In this way, when the top sealing area is located on one side in the width direction of the soft pack battery, one or more breathable holes arranged along the length direction of the soft pack battery are provided within the top sealing area that extends along the length direction of the soft pack battery, maximally utilizing the top sealing area and providing a good gas exhaust effect.

In an achievable manner, the tabs are provided on two opposite sides of the soft pack battery, the top sealing area is provided on two opposite sides of the packaging film, and the breathable hole is provided within the top sealing area on at least one side of the packaging film.

In an achievable manner, the tabs are provided on two opposite sides of the soft pack battery in a length direction of the soft pack battery, the top sealing area is provided on two opposite sides of the packaging film in the length direction of the soft pack battery, the top sealing area extends along a width direction of the soft pack battery, and the number of the breathable hole is one or more. When the number of the breathable hole is multiple, the multiple breathable holes can be arranged along the width direction of the soft pack battery. Thus, when the top sealing area is located on two opposite sides in the length direction of the soft pack battery, one or more breathable holes arranged along the width direction of the soft pack battery are provided within the top sealing area that extends along the width direction of the soft pack battery, maximally utilizing the top sealing areas on both sides and providing a good gas exhaust effect.

In an achievable manner, the soft pack battery further comprises a battery cell, the battery cell is provided within the packaging film, one end of the tab is connected to the battery cell, a tab adhesive is provided on the tab, the tab adhesive is located within the top sealing area, and the breathable hole is located between the tab adhesive and the battery cell.

Thus, the tab adhesive can not only prevent short circuits caused by contact between the packaging film and the tab, but also prevent electrolyte leakage inside the battery. Since the sealing position between the tab and the packaging film corresponds to the position of the tab adhesive, and the breathable hole is located between the tab adhesive and the battery cell, the position of the breathable hole is not sealed, allowing the gas inside the packaging film to be smoothly discharged through the breathable hole.

In an achievable manner, the breathable holes account for 1%-80%, or 5%-60%, or 10%-40% of the top sealing area.

In an achievable manner, the soft pack battery is provided with tabs, the tabs are provided on one side of the soft pack battery in a width direction of the soft pack battery, the breathable hole is provided on one side or two opposite sides of the packaging film in a length direction of the soft pack battery, and the number of the breathable hole on each side is one or more. When there are multiple breathable holes on each side, the multiple breathable holes on each side can be arranged along the width direction of the soft pack battery.

In an achievable manner, the soft pack battery is provided with tabs, the tabs are provided on two opposite sides of the soft pack battery in a length direction of the soft pack battery, the breathable hole is provided on one side or two opposite sides of the packaging film in a width direction of the soft pack battery, and the number of the breathable hole on each side is one or more. When there are multiple breathable holes on each side, the multiple breathable holes on each side can be arranged along the length direction of the soft pack battery.

In an achievable manner, the area of the breathable hole is in the range from 0.0001 mm² to 900 mm², or 0.01 mm² to 9 mm².

In an achievable manner, the breathable membrane is joined to the packaging film by adhesive bonding; alternatively, the breathable membrane is joined to the inner and/or outer surface of the packaging film by adhesive bonding.

In an achievable manner, the gas that can pass through the breathable membrane includes CO₂, CO, N₂, CH₄, C₂H₄, C₂H₂, and O₂.

### Beneficial Effects

The soft pack battery provided in this application is provided with a breathable hole on the packaging film, and a breathable membrane is provided at the position of the breathable hole. The breathable membrane can block liquid while allowing gas to pass therethrough. When gas is generated inside the soft pack battery and reaches a certain pressure, the gas can be discharged to the outside of the soft pack battery through the breathable membrane, thereby avoiding deformation of the battery cell or rupture of the packaging film due to an excessive large internal pressure. The battery can still be used after the gas is exhausted, improving the safety performance and service life of the battery. Also, compared to other solutions with gas exhaust valves, this structure has a simple sealing process, high strength, long service life, and the mass of the breathable membrane is small, which does not affect the energy density of the battery.

### BRIEF DESCRIPTION OF THE DRAWINGS

FIG. 1 is a cross-sectional schematic diagram of a soft pack battery in a first embodiment of the present application.

FIG. 2 is a cross-sectional schematic diagram of a soft pack battery in a second embodiment of the present application.

FIG. 3 is a cross-sectional schematic diagram of a soft pack battery in a third embodiment of the present application.

FIG. 4 is a cross-sectional schematic diagram of a soft pack battery in a fourth embodiment of the present application.

FIG. 5 is a cross-sectional schematic diagram of a soft pack battery in a fifth embodiment of the present application.

FIG. 6 is a cross-sectional schematic diagram of a soft pack battery in a sixth embodiment of the present application.

### DETAILED DESCRIPTION OF THE EMBODIMENTS

The following will provide a further detailed description of the specific implementations of the present application in conjunction with the accompanying drawings and embodiments. The following embodiments are used to illustrate the present application, but are not intended to limit the scope of the present application.

The terms “first”, “second”, “third”, “fourth”, etc. (if any) in the specification and claims of the present application are only used to distinguish similar objects, and are not intended to be used to describe a specific sequence or order.

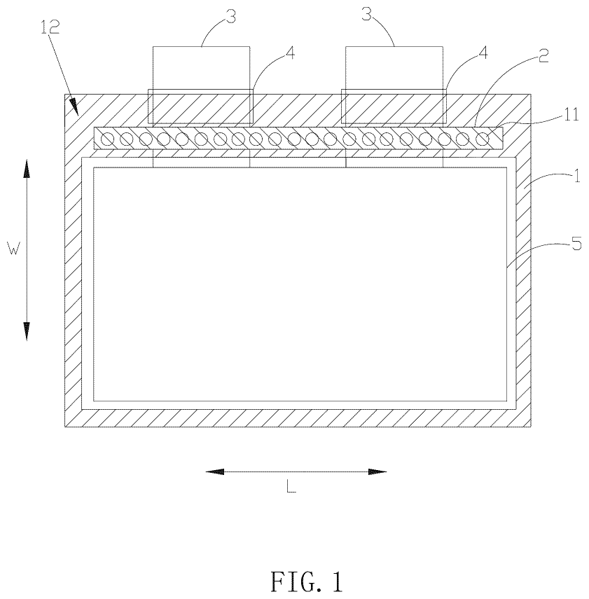

Referring to an embodiment shown in FIG. 1, the present application provides a soft pack battery, including a packaging film 1. The packaging film 1 is provided with a breathable hole 11. The soft pack battery further includes a breathable membrane 2. The breathable membrane 2 is attached and connected to the packaging film 1 at the position of the breathable hole 11, and the breathable membrane 2 seals the breathable hole 11. The breathable membrane 2 can block liquid while allowing gas to pass therethrough.

As an achievable manner, the packaging film 1 is an aluminum-plastic film.

As shown in FIG. 1, as an achievable manner, at least one side of the soft pack battery is provided with one or more tabs 3, and the packaging film 1 is provided with a top sealing area 12 (i.e., the area where the packaging film 1 is packaged) at the position corresponding to the tabs 3. The breathable hole 11 is provided within the top sealing area 12.

As shown in FIG. 1, as an achievable manner, the soft pack battery further includes a battery cell 5, and the battery cell 5 is packaged inside the packaging film 1. One end of the tab 3 is connected to the battery cell 5, and the other end of the tab 3 is exposed outside the packaging film 1. An electrolyte is provided inside the packaging film 1, and the battery cell 5 is immersed in the electrolyte.

Specifically, since the breathable membrane 2 is able to block liquid while allowing gas to pass therethrough, the electrolyte inside the packaging film 1 cannot leak from the breathable membrane 2. Meanwhile, due to the continuous generation of gas inside the soft pack battery, the gas pressure inside the soft pack battery is generally higher than the external pressure. Under the pressure difference between the inside and outside of the soft pack battery, the gas inside the soft pack battery can be discharged through the breathable membrane 2, and the external gas cannot enter the soft pack battery through the breathable membrane 2.

As shown in FIG. 1, as an achievable manner, when the soft pack battery adopts a structure with the tabs 3 extending out from a single side, the tabs 3 are provided on one side of the soft pack battery.

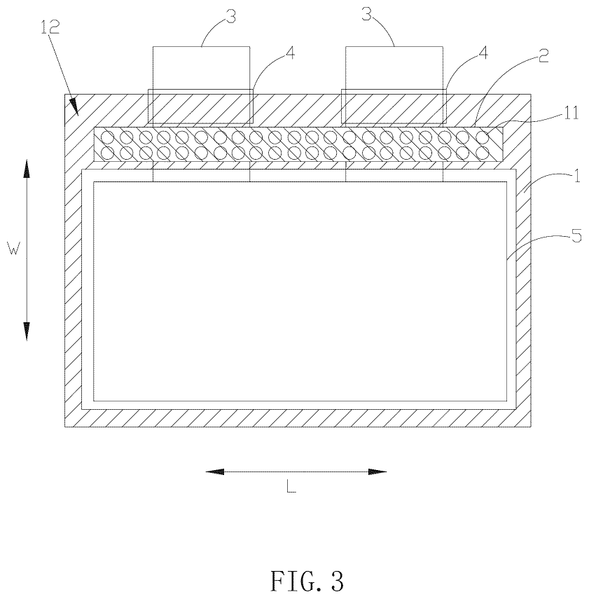

As shown in FIG. 1, as an achievable manner, the tabs 3 are provided on one side of the soft pack battery in a width direction W of the soft pack battery. The top sealing area 12 is provided on the side of the packaging film 1 near the tabs 3, and the top sealing area 12 extends along a length direction L of the soft pack battery. The number of the breathable hole 11 is multiple, and the multiple breathable holes 11 are arranged along the length direction L of the soft pack battery. The multiple breathable holes 11 are arranged in a row along the length direction L of the soft pack battery. Of course, as shown in FIG. 3, in other embodiments, the multiple breathable holes 11 can also be arranged in two or more rows along the length direction L of the soft pack battery. Alternatively, the multiple breathable holes 11 may not be arranged linearly.

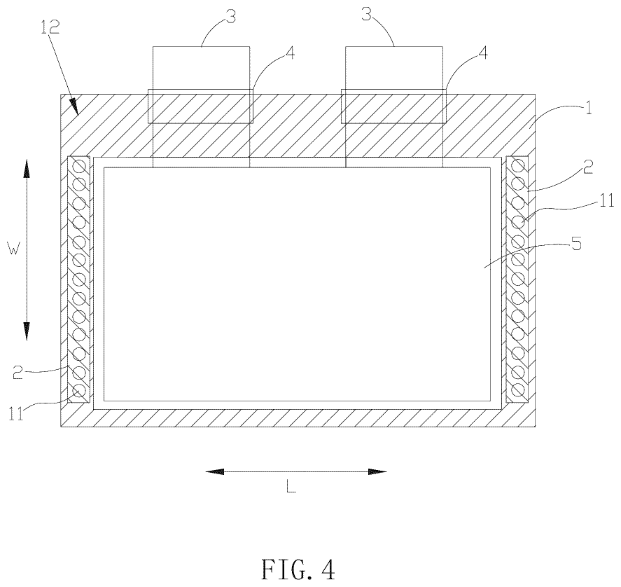

As shown in FIG. 4, as another achievable manner, the breathable hole 11 may not be provided within the top sealing area 12. Specifically, the soft pack battery is provided with tabs 3, and the tabs 3 are provided on one side of the soft pack battery in the width direction W of the soft pack battery. The breathable hole 11 is provided on one side or two opposite sides of the packaging film 1 in the length direction L of the soft pack battery. The number of the breathable hole 11 on each side is multiple, and the multiple breathable holes 11 on each side are arranged along the width direction W of the soft pack battery. Of course, in other embodiments, the multiple breathable holes 11 can also be arranged in a W-shaped, L-shaped, or irregular arrangement.

As shown in FIG. 1, as an achievable manner, there are two tabs 3, and the two tabs 3 are respectively a positive tab and a negative tab. The positive and negative tabs are connected to the positive and negative poles of the battery cell 5.

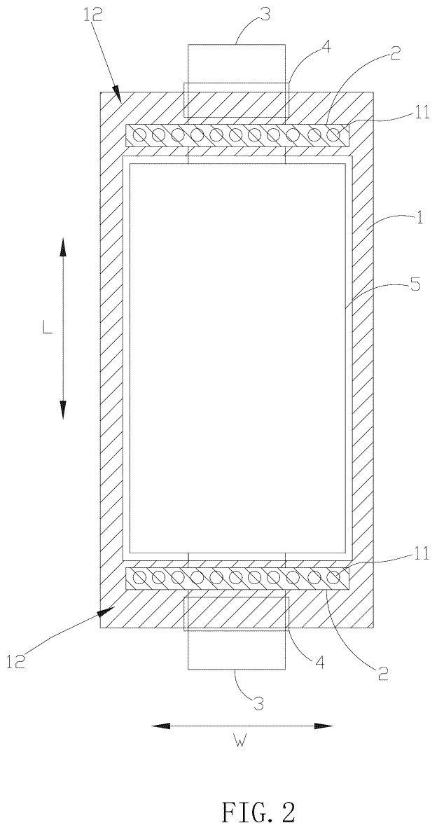

As shown in FIG. 2, as another achievable manner, when the soft pack battery adopts a structure with the tabs 3 extending out from two sides, the tabs 3 are provided on two opposite sides of the soft pack battery. The top sealing area 12 is provided on two opposite sides of the packaging film 1, and the breathable hole 11 is provided within the top sealing area 12 on at least one side of the packaging film 1.

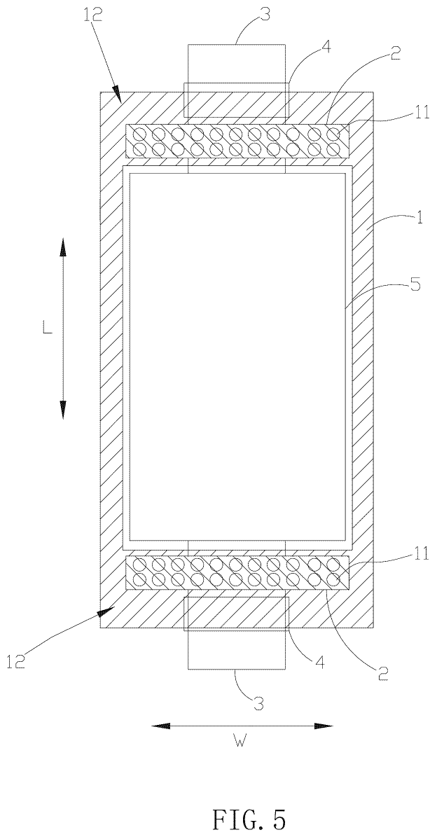

As shown in FIG. 2, as another achievable manner, the tabs 3 are provided on two opposite sides of the soft pack battery in the length direction L of the soft pack battery. The top sealing area 12 is provided on two opposite sides of the packaging film 1 in the length direction L of the soft pack battery, and the top sealing area 12 extends along the width direction W of the soft pack battery. There are multiple breathable holes 11, and the multiple breathable holes 11 are arranged along the width direction W of the soft pack battery, and the multiple breathable holes 11 on each side are arranged in a row along the width direction W of the soft pack battery. Of course, as shown in FIG. 5, in other embodiments, the multiple breathable holes 11 on each side can also be arranged in two or more rows along the width direction W of the soft pack battery. Alternatively, the multiple breathable holes 11 may not be arranged linearly.

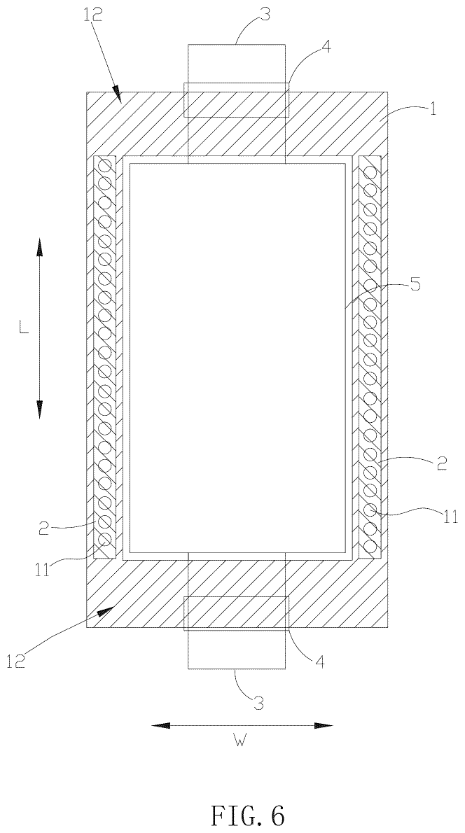

As shown in FIG. 6, as another achievable manner, the breathable hole 11 may not be provided within the top sealing area 12. Specifically, the soft pack battery is provided with tabs 3, and the tabs 3 are provided on two opposite sides of the soft pack battery in the length direction L of the soft pack battery. The breathable hole 11 is provided on one side or two opposite sides of the packaging film 1 in the width direction W of the soft pack battery. The number of the breathable hole 11 on each side is multiple, and the multiple breathable holes 11 on each side are arranged along the length direction L of the soft pack battery. Of course, in other embodiments, the multiple breathable holes 11 can also be arranged in a W-shaped, L-shaped, or irregular arrangement.

As shown in FIG. 1, as an achievable manner, a tab adhesive 4 is provided on the tab 3, and the tab adhesive 4 is located within the top sealing area 12. The breathable hole 11 is located between the tab adhesive 4 and the battery cell 5.

Specifically, the tab adhesive 4 is used for hot melt sealing between the packaging film 1 and the tab 3. During the packaging process of the soft pack battery, the corresponding position of the tab adhesive 4 between the tab 3 and the packaging film 1 is heat sealed, that is, the sealing position between the tab 3 and the packaging film 1 corresponds to the position of the tab adhesive 4, so that the tab adhesive 4 is melted by heat to achieve the connection between the tab 3 and the packaging film 1. Since the sealing position between the tab 3 and the packaging film 1 corresponds to the position of the tab adhesive 4, and the breathable hole 11 is located between the tab adhesive 4 and the battery cell 5, the position of the breathable hole 11 is not sealed, allowing the gas inside the packaging film 1 to be smoothly discharged through the breathable hole 11.

As an achievable manner, the breathable holes 11 account for 1%-80% of the area of the top sealing area 12.

As another achievable manner, the breathable holes 11 account for 5%-60% of the area of the top sealing area 12.

As another achievable manner, the breathable holes 11 account for 10%-40% of the area of the top sealing area 12.

As an achievable manner, the area of the breathable hole 11 is in the range from 0.01 mm² to 900 mm².

As another achievable manner, the area of the breathable hole 11 is in the range from 0.01 mm² to 9 mm².

As an achievable manner, the shape of the breathable hole 11 can be regular shapes such as circular, elliptical, square, rectangular, diamond, etc. Of course, it can also be other irregular shapes without limitation.

As an achievable manner, the breathable membrane 2 and the packaging film 1 are joined by adhesive bonding. The breathable membrane 2 can be attached to the inner surface of the packaging film 1, the outer surface of the packaging film 1, or both. The bonding method between the breathable membrane 2 and the packaging film 1 can be bonded by adhesion, hot pressing, or hot melting. Preferably, the breathable membrane 2 and the packaging film 1 can be bonded by adhesion or hot pressing.

As an achievable manner, the gas that can pass through the breathable membrane 2 includes CO₂, CO, N₂, CH₄, C₂H₄, C₂H₂, and O₂.

As an achievable manner, the breathable membrane 2 is made of materials including, but is not limited to, polysulfone and its derivatives, fluorinated polymer, polyphenylene ether and its derivatives, polydimethylsiloxane and its derivatives, polyamide or polyimide and its derivatives, polyurethane or polyester and its derivatives, polyolefin and its derivatives, etc. Preferably, the material of the breathable membrane 2 can be polyolefin derivative, such as polyacrylonitrile; or fluorinated polymer, such as polytetrafluoroethylene; or polydimethylsiloxane and its derivatives, such as polydimethylsiloxane. The material of the breathable membrane 2 can also be a mixture of two or more materials mentioned above, and the mixing method can be direct mixing or multi-layer composite.

As an achievable manner, the relative molecular weight of the material of the breathable membrane 2 is 10³-10⁸, and the molecular weight distribution index is 1.0-3.0. Preferably, the relative molecular weight of the material of the breathable membrane 2 is 10⁵-10⁷, and the molecular weight distribution index is 1.0-1.5.

The soft pack battery provided in the embodiments of the present application is provided with a breathable hole 11 on the packaging film 1, and a breathable membrane 2 is provide at the position of the breathable hole 11. The breathable membrane 2 can block liquid while allowing gas to pass therethrough. When gas is generated inside the soft pack battery and reaches a certain pressure, the gas can be discharged to the outside of the soft pack battery through the breathable membrane 2, thereby avoiding deformation of the battery cell 5 or rupture of the packaging film 1 due to an excessive large internal pressure. The battery can still be used after the gas is exhausted, improving the safety performance and service life of the battery. Also, compared to other solutions with gas exhaust valves, this structure has a simple packaging process, high strength, long service life, and the mass of the breathable membrane 2 is small, which does not affect the energy density of the battery.

The above is only the specific implementation of the present application, but the scope of protection of the present application is not limited to this. Any skilled person familiar with the technical field within the scope of the disclosed technology can easily think of changes or replacements, which should be covered within the scope of protection of the present application. Therefore, the scope of protection of the present application shall be based on the protection scope of the claims.

### INDUSTRIAL APPLICABILITY

The soft pack battery provided in this application is provided with a breathable hole on the packaging film, and a breathable membrane is provided at the position of the breathable hole. The breathable membrane can block liquid while allowing gas to pass therethrough. When gas is generated inside the soft pack battery and reaches a certain pressure, the gas can be discharged to the outside of the soft pack battery through the breathable membrane, thereby avoiding deformation of the battery cell or rupture of the packaging film due to an excessive large internal pressure. The battery can still be used after the gas is exhausted, improving the safety performance and service life of the battery. Also, compared to other solutions with gas exhaust valves, this structure has a simple packaging process, high strength, long service life, and the mass of the breathable membrane is small, which does not affect the energy density of the battery.

1. A soft pack battery, comprising a packaging film, wherein at least one breathable hole is provided on the packaging film, the soft pack battery further comprises a breathable membrane, the breathable membrane seals the breathable hole, and the breathable membrane is capable of blocking liquid while allowing gas to pass therethrough.

2. The soft pack battery as claimed in claim 1, wherein at least one side of the soft pack battery is provided with one or more tabs, the packaging film is provided with a top sealing area at the position corresponding to the tabs, and the breathable hole is provided within the top sealing area.

3. The soft pack battery as claimed in claim 2, wherein the tabs are provided on one side of the soft pack battery.

4. The soft pack battery as claimed in claim 3, wherein the tabs are provided on one side of the soft pack battery in a width direction of the soft pack battery, the top sealing area is provided on the side of the packaging film near the tabs, the top sealing area extends along a length direction of the soft pack battery, and the number of the breathable hole is one or more.

5. The soft pack battery as claimed in claim 2, wherein the tabs are provided on two opposite sides of the soft pack battery, and the breathable hole is provided within the top sealing area on at least one side of the packaging film.

6. The soft pack battery as claimed in claim 5, wherein the tabs are provided on two opposite sides of the soft pack battery in a length direction of the soft pack battery, the top sealing area is provided on two opposite sides of the packaging film in the length direction of the soft pack battery, the top sealing area extends along a width direction of the soft pack battery, and the number of the breathable hole is one or more.

7. The soft pack battery as claimed in claim 2, wherein the soft pack battery further comprises a battery cell, the battery cell is provided within the packaging film, one end of the tab is connected to the battery cell, a tab adhesive is provided on the tab, the tab adhesive is located within the top sealing area, and the breathable hole is located between the tab adhesive and the battery cell.

8. The soft pack battery as claimed in claim 2, wherein the breathable holes account for 1%-80% of the area of the top sealing area.

9. The soft pack battery as claimed in claim 1, wherein the soft pack battery is provided with tabs, the tabs are provided on one side of the soft pack battery in a width direction of the soft pack battery, the breathable hole is provided on one side or two opposite sides of the packaging film in a length direction of the soft pack battery, and the number of the breathable hole on each side is one or more.

10. The soft pack battery as claimed in claim 1, wherein the soft pack battery is provided with tabs, the tabs are provided on two opposite sides of the soft pack battery in a length direction of the soft pack battery, the breathable hole is provided on one side or two opposite sides of the packaging film in a width direction of the soft pack battery, and the number of the breathable hole on each side is one or more.

11. The soft pack battery as claimed in claim 1, wherein the area of the breathable hole is in the range from 0.0001 mm² to 900 mm².

12. The soft pack battery as claimed in claim 1, wherein the breathable membrane is joined to the packaging film by adhesive bonding.

13. The soft pack battery as claimed in claim 3, wherein the breathable holes account for 1%-80% of the area of the top sealing area.

14. The soft pack battery as claimed in claim 4, wherein the breathable holes account for 1%-80% of the area of the top sealing area.

15. The soft pack battery as claimed in claim 5, wherein the breathable holes account for 1%-80% of the area of the top sealing area.

16. The soft pack battery as claimed in claim 6, wherein the breathable holes account for 1%-80% of the area of the top sealing area.

17. The soft pack battery as claimed in claim 7, wherein the breathable holes account for 1%-80% of the area of the top sealing area.
